(19) United States
(12) Patent Application Publication
(10) Pub. No.: US 2005/0019137 A1
(43) Pub. Date: Jan. 27, 2005

(54) Self-piercing rivet fastening device and die used by the fastening device

(76) Inventors: Shuichiro Iwatsuki, Utsunomiya (JP); Masashi Fujita, Kawachi (JP); Nobuharu Naitoh, Hamamatsu (JP); Tatsuo Asaoka, Sakai (JP); Masaki Yamazaki, Sakai (JP)

Correspondence Address: HARNESS, DICKEY & PIERCE, P.L.C., P.O. BOX 828, BLOOMFIELD HILLS, MI, 48303, US

(21) Appl. No.: 10/868,176

(22) Filed: Jun. 15, 2004

Related U.S. Application Data
(63) Continuation of application No. PCT/JP02/13746, filed on Dec. 27, 2002.

(30) Foreign Application Priority Data
Dec. 27, 2001 (JP) 2001-397363
Dec. 27, 2001 (JP) 2001-395691

(51) Int. Cl. F16B 19/08

(52) U.S. Cl. 411/501

(57) ABSTRACT

The die 18 of the self-piercing rivet fastening device is equipped with a center pin 25 for receiving the hollow section of the legs 5 on the self-piercing rivet 1 and a die main body 27 having a cavity 26 for guiding the distortion of the tip of the legs on the self-piercing rivet outward radially on the outer periphery of the center pin 25. The center pin 25 and the die main body 27 are supported so as to move relatively freely in the axial direction of the center pin 25 towards the punch 14. It also has a plate spring 41 allowing the center pin 25 to move relative to the die main body 27 so the center pin 25 comes into contact with the die end surface of the fastened member 3 on the receiving end when the self-piercing rivet 1 under pressure from the punch 14 is driven into the fastened members 2, 3 and the tip of the legs begins to pierce the fastened member 3 on the receiving end. This reduces or eliminates the constraints on the fastened members in the rivet-driving direction.

### CROSS-REFERENCE TO RELATED APPLICATIONS

This application is a continuation of a PCT Application No. PCT/JP02/13746, filed Dec. 27, 2002, which claims priority to Japanese Patent Application No. 2001-397363, filed Dec. 27, 2001 and Japanese Patent Application No. 2001-395691, filed Dec. 27, 2001, which are incorporated by reference herein.

### FIELD OF THE INVENTION

The present invention relates to a self-piercing rivet fastening device and a die used on this fastening device and, more specifically, to a self-piercing rivet fastening technology using a self-piercing rivet to fasten at least two but possibly also three or more fastened members such as panels (or panels and components) together during the panel assembly operation (such as the aluminum body assembly operation) in automotive assembly.

### BACKGROUND OF THE INVENTION

One example of a self-piercing rivet fastening device is described in Japanese Examined Patent Application Disclosure [Kokoku] No.8-505087. An example of this self-piercing fastening device is shown in FIG. 1. When self-piercing rivet with a large-diameter head and hollow legs extending below the head is driven into fastened members such as two body panels by the punch and die on the fastening device, the legs pierce the panels and the tip of the legs expands so the fastened members are fastened together by the expanded legs and the large-diameter head of the rivet. Demand for self-piercing rivets that connect aluminum body panels together without welding has grown as the use of aluminum panels in automobile bodies has become increasingly popular as a means of reducing weight. A self-piercing rivet penetrates the fastened member on the punch end and does not penetrate the fastened member on the receiving end adjacent to the die but instead remains inside the fastened member. Consequently, the rivet does not make a hole in the surface of the fastened member on the receiving end. This keeps the fastened member on the receiving end sealed and maintains the outward appearance of the fastened member.

When the fastened member on the punch end is thicker than the fastened member on the receiving end adjacent to the die in the driving direction of the self-piercing rivet from the punch, the radial penetrating length or amount of undercut allowing the rivet legs to penetrate the fastened member on the receiving end at an angle does not provide sufficient joining strength. This situation is shown in FIG. 1. In FIG. 1, a self-piercing rivet 1 is driven into two fastened members 2, 3 to fasten the fastened member on the punch end 2 (there is only one fastened member on the punch end in this figure, but multiple fastened members on the punch end are possible) to the fastened member on the receiving end 3 adjacent to the die. The self-piercing rivet 1 has a large-diameter head 4 and hollow legs 5 extending below the head. If the fastened member on the punch end 2 is thicker than the fastened member on the receiving end 3, the radial penetrating length or amount of undercut 6 allowing the legs 5 on the self-penetrating rivet to penetrate the fastened member on the receiving end 3 at an angle does not provide enough strength to join the fastened member on the receiving end 2 to the fastened member on the punch end 3. At the present time, the ratio of the thickness of the fastened member on the punch end to the thickness of the fastened member on the receiving end adjacent to the die cannot exceed 2:1 if sufficient joining strength is to be provided.

When there is a change in the thickness or the number of fastened members, a die with a different recess diameter (plate diameter), depth (plate depth) and protrusion height (protruding height) in the center of the die recess has to be installed or a self-piercing rivet with a different leg length or leg diameter has to be used so the fastened member on the bottom, which is the sealed fastened member when the fastening operation has been completed, is not pierced by the self-piercing rivet yet is fastened securely to the other fastened members. The dies used here are integrated metal dies.

When integrated metal dies are used, different dies and self-piercing rivets have to be prepared for any change to the fastened members. The storage of these dies and rivets is cumbersome, operating costs are increased, and the time required to change the self-piercing rivets and dies results in a loss of productivity. In order to eliminate the loss of time and reduce costs, multiple fastening devices with different self-piercing rivets and dies are needed. These fastening devices take up space and increase equipment costs for fastening devices.

If the self-piercing rivet and die are not replaced when the thickness and the number of fastened members changes, they are not set for the vertical height of the bottom fastened member when the self-piercing rivet is driven into the fastened member, the timing on which the bottom fastened member makes contact with the protrusion on the die end is off, and the self-piercing rivet may pierce the bottom fastened member and break the seal. If the seal is broken, a gap opens both between the self-piercing rivet and the fastened member and between the fastened members themselves. This weakens the fastening strength or leads to uneven fastening strength. The fastened member near the head of the self-piercing rivet is also warped.

Because of this constraint, the fastened member on the receiving end has to be less than 1/2 the thickness of the other fastened members in the rivet-driving direction of the self-piercing rivet. If the thickness of the fastened member 2 to the thickness of the other fastened members 3 in FIG. 1 is a ratio greater than 2:1, such as 3:1 or 4:1, and a self-piercing rivet is driven into the fastened member 3 on the receiving end, the amount of under cut is insufficient, as shown in the figure, to join the members together adequately. If the rivet fastening device is reversed so that fastened member 2 becomes the fastened member on the receiving end or if fastened member 2 and fastened member 3 are reversed so that fastened member 2 becomes the fastened member on the receiving end, the fastened members 2, 3 can be joined together with sufficient strength. However, it takes time to either reverse the fastening device or the fastened members. As a result, the fastening operation cannot be performed quickly. Due to constraints on the shape of the fastened members and constraints on the fastening position, the device and fastened members often cannot be reversed.

A self-piercing rivet fastening device has been disclosed in International Patent Application Disclosure No. WO 00/23213 in which the die consists of a die main body fixed to the fastening device main body and a groove for a center pin supported so as to be able to move freely in the axial direction inside the die main body. Here, the die main body also has a cavity for guiding the deformation of the tip of the legs on the self-penetrating rivet outward radially. Because this fastening device positions the center of the legs on the self-piercing rivet before the self-piercing rivet is driven into the fastened members, the protruding center pin makes contact with the fastened members, and the center pin is drawn into the die main body in the final stage of rivet insertion. Because the self-piercing rivet fastening device of the prior art performs centering during insertion of the self-piercing rivet, it does not eliminate the problem with insufficient undercut in the fastened members.

### SUMMARY OF THE INVENTION

Therefore, the first purpose of the present invention is to provide a self-piercing rivet fastening device that reduces or eliminates the constraints on the fastened members in the rivet-driving direction. If the self-piercing rivet and die are not replaced when the thickness and the number of fastened members changes, a gap opens both between the self-piercing rivet and the fastened member and between the fastened members themselves. This weakens the fastening strength or leads to uneven fastening strength. The fastened member near the head of the self-piercing rivet is also warped. Therefore, the second purpose of the present invention is to provide a self-piercing rivet fastening device and a die for a self-piercing fastening device that can fasten the fastening members without the seal being broken, without gaps opening between the self-piercing rivet and the fastening members or between fastening members themselves, without warping the fastened member near the head of the rivet, and without having to change the self-piercing rivet (to a rivet with a different overall length) or the die (to a die with a different recess diameter or recess depth) even when the thickness or the number of fastened members is changed.

The present invention achieves the first purpose by providing a self-piercing rivet fastening device having a punch and die for driving a self-piercing rivet with a large-diameter head and hollow legs extending below the head into a plurality of fastened members, the tip of the legs becoming deformed as the legs penetrate the fastened members when the self-piercing rivet is driven into the fastened members so as to expand outward radially, the tip of the legs not penetrating the fastened member on the receiving end adjacent to the die but remaining inside, the plurality of fastened members being connected to each other by the deformed legs and the large-diameter head, wherein the die comprises a center pin in the position receiving the hollow section of the legs on the self-piercing rivet and extending towards the punch as well as a die main body with a cavity for guiding the outward radial deformation of the tip of the legs on the self-piercing rivet, wherein the center pin and the die main body are supported so as to move relatively freely in the radial direction of the center pin towards the punch, and wherein the device has a means allowing the center pin to move relative to the die main body so the center pin comes into contact with the die end surface of the fastened member on the receiving end when the self-piercing rivet under pressure from the punch is driven into the plurality of fastened members and the tip of the legs begins to pierce the fastened member on the receiving end.

In this self-piercing rivet fastening device, the center pin on the die main body comes into contact with the receiving-end fastened member on the die end when the tip of the legs on the self-piercing rivet penetrate the fastened member on the receiving end adjacent to the die, but the center pin does not act on the fastened member on the receiving end. Consequently, the legs of the self-piercing rivet penetrate the fastened member on the receiving end without expanding outward. When the legs of the rivet begin to penetrate the fastened member on the receiving end, the center pin rises up and the tip of the legs on the rivet begins to expand outward radially to a significant degree. The expansion provides an adequate amount of undercut. The amount of undercut even provides enough joining force when the thickness of the fastened member on the receiving end is less than 1/2 the thickness of the other fastened member (i.e., the fastened member on the punch end). This reduces or eliminates the constraints on the fastened members in the rivet-driving direction. Unlike fastening devices of the prior art, the effort required to reverse the fastening device or reverse the fastened members is reduced or eliminated. Consequently, the fastening process can be performed quickly. Fastening can also be performed in directions impossible using a fastening device of the prior art. This eliminates constraints on fastening positions, and expands the places or positions where a self-piercing rivet can be applied.

This device is equipped with a C-shaped frame, in which the punch is attached at one end of the C-shaped frame so as to move towards the other end of the C-shaped frame, in which the die is attached to the other end of the C-shaped frame facing the punch so as to receive the self-piercing rivet driven by the punch, in which the die main body is supported by the other end of the C-shaped frame so as to be able to move in the axial direction of the center pin, in which the center pin is fixed to the other end of the C-shaped frame in order to penetrate the die main body so the tip of the pin protrudes towards the punch, and in which the means for moving the center pin relative to the die main body is a spring means disposed between the ends of the C-shaped frame and applying pressure to the die main body on the punch end.

Here, the movable die main body comprises a large-diameter tube-shaped portion on the punch end and a small-diameter tube-shaped portion sliding into an attachment hole on the other end of the C-shaped frame, in which a hole for slidably receiving the center pin passes through the center of both tube-shaped portions forming a hollow tube, in which the spring means is a plate spring attached between the large-diameter tube-shaped portion and the C-shaped frame, and in which the spring action from the plate spring forces the movable die main body towards the punch end when the tip of the legs on the self-piercing rivet driven by the punch is driven through the fastened members and enters the fastened member on the receiving end, moving the die main body towards the C-shaped frame and bringing the center pin into contact with the surface of the receiving-end fastened member on the die end when the tip of the legs on the self-piercing rivet driven by the punch begins to pierce the fastened member on the receiving end and strong pressure is applied.

Also, the other end of the C-shaped frame has an attachment hole for slidably accommodating the small-diameter tube-shaped portion of the die main body, a large-diameter center-pin accommodating hole continuing the attachment hole is formed on the opposite side of the other end of the C-shaped frame facing the punch end, the small-diameter tube-shaped portion of the die main body is slidably attached to the attachment hole, female threading is formed on the inside wall of the center-pin accommodating hole, and the center pin is screwed into the female threading.

The device can also be equipped with a C-shaped frame, in which the punch is attached at one end of the C-shaped frame so as to move towards the other end of the C-shaped frame, in which the die is attached to the other end of the frame facing the punch so as to receive the self-piercing rivet driven by the punch, in which the die main body is fixed to the other end of the frame, in which a center-pin accommodating chamber is formed in the die main body to allow the tip of the pin to pass through the die main body and protrude towards the punch, in which the center pin is supported so as to be able to move freely in the axial direction of the pin inside the center-pin accommodating chamber, and in which the means for moving the center pin relative to the die main body is a fluid pressure or air pressure means using fluid pressure or air pressure to push the center pin against the punch end.

The present invention achieves the second purpose by providing a self-piercing rivet fastening device, wherein the device is equipped with a die for deforming and fastening the hollow legs of a self-piercing rivet consisting of a large-diameter head and hollow legs extending down from the head, and a punch reciprocating in the direction of the punch, wherein the die consists of an outer tube, an inner tube making contact with the inside surface of the outer tube and able to move forward and backward inside the outer tube, and a center pin having a protrusion in the center of the tip making contact with the inside surface of the inner tube and able to move forward and backward inside the inner tube, wherein the die is connected to an inner-tube moving means for moving the inner tube forward and backward and a center-pin moving means for moving the center pin forward and backward, wherein the moving means move with the punch, wherein the tip of the inner tube, the tip of the protrusion on the center pin and the tip of the outer tube are roughly coplanar until the self-piercing rivet punches through a fastened member lengthwise based on the conditions of the thickness of the fastened member and the overall length of the self-piercing rivet, wherein the inner tube and the center pin move backward separately to specific positions and stop after the self-piercing rivet punches through a fastened member lengthwise based on the conditions of the thickness of the fastened member and the overall length of the self-piercing rivet, wherein the speed at which the inner tube and the center pin move backwards at this time is approximately the same speed as the punch, and wherein the edge of the tip on the center pin and the tip of the inner tube are roughly coplanar when the inner tube and the center pin reach their respective positions.

Here, the inner tube moving means and the center pin moving means consist of ring mechanisms and cam mechanisms for converting the movement of the punch into forward and backward movement of the inner tube and center pin. Also, the device is equipped with a stop position setting means for setting and changing the backward stop position of the inner tube and the backward stop position of the center pin based on the thickness of the fastened member and/or the overall length of the self-piercing rivet.

The present invention is also a die for deforming and fastening the hollow legs of a self-piercing rivet consisting of a large-diameter head and hollow legs extending down from the head, wherein the die consists of an outer tube, an inner tube making contact with the inside surface of the outer tube and able to move forward and backward inside the outer tube, and a center pin having a protrusion in the center of the tip making contact with the inside surface of the inner tube and able to move forward and backward inside the inner tube, wherein the die is connected to an inner-tube moving means for moving the inner tube forward and backward and a center-pin moving means for moving the center pin forward and backward, wherein the moving means move with the punch, wherein the tip of the inner tube, the tip of the protrusion on the center pin and the tip of the outer tube are roughly coplanar until the self-piercing rivet punches through a fastened member lengthwise based on the conditions of the thickness of the fastened member and the overall length of the self-piercing rivet, wherein the inner tube and the center pin move backward separately to specific positions and stop after the self-piercing rivet punches through a fastened member lengthwise based on the conditions of the thickness of the fastened member and the overall length of the self-piercing rivet, wherein the speed at which the inner tube and the center pin move backwards at this time is approximately the same speed as the punch, and wherein the edge of the tip on the center pin and the tip of the inner tube are roughly coplanar when the inner tube and the center pin reach their respective positions. The self-piercing rivet fastening device and die described above solve the problems associated with the prior art.

### BRIEF EXPLANATION OF THE DRAWINGS

FIG. 1 is a cross-sectional view of fastened members fastened together by a self-piercing rivet driven into the members by a fastening device of the prior art.

FIG. 2 is a simplified front view of the self-piercing rivet fastening device in the first embodiment of the present invention.

FIG. 3 is a cross-sectional view of the die portion of the self-piercing rivet fastening device in the first embodiment of the present invention.

FIG. 4 is a cross-sectional view of the die and punch portions when a self-piercing rivet is being driven into fastened members using the self-piercing rivet fastening device in FIG. 2 and FIG. 3.

FIG. 5 is a cross-sectional view of the portions in FIG. 4 after the self-piercing rivet has been driven into the fastened members by the self-piercing rivet fastening device of the present invention and the fastened members have been fastened together.

FIG. 6 is a cross-sectional view of the die portion of the self-piercing rivet fastening device in another embodiment of the present invention.

FIG. 7 is a partial cross-sectional view from the side of the self-piercing rivet fastening device of the present invention.

FIG. 8 is a partial cross-sectional view of the fastening device in FIG. 7 from direction A.

FIG. 9 is a partial cross-sectional view of the die in FIG. 7 from direction A.

FIG. 10 is a partial cross-sectional view of the die (including the inner tube moving means) in FIG. 7 from the side.

FIG. 11 is a partial cross-sectional view of the die (including the center pin moving means) in FIG. 7 from the side.

FIGS. 12A through C are cross-sectional views of the various operating stages of the die. FIG. 12A shows the initial fastening stage, FIG. 12B shows the intermediate fastening stage, and FIG. 12C shows the final fastening stage.

FIG. 13 is a cross-sectional view of fastening members fastened by the fastening device of the present invention.

### PREFERRED EMBODIMENTS OF THE PRESENT INVENTION

The following is an explanation of embodiments of the present invention with reference to the drawings. First, embodiments of the present invention corresponding to the first purpose will be explained.

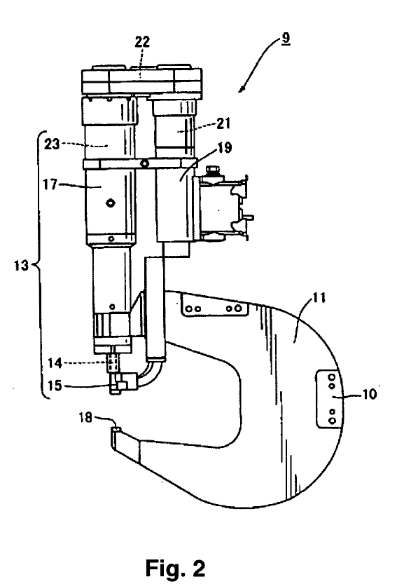

FIG. 2 is a simplified diagram of the entire self-piercing rivet fastening device 9 in the first embodiment of the present invention. In FIG. 2, the self-piercing rivet device 9 has a C-shaped frame 11 with a connector 10 to an articulated robot arm (not shown). The C-shaped frame 11 is rigid with an integrated upper horizontal arm portion, a vertical arm portion attached to the connector 10, and a lower horizontal arm portion. The fastening mechanism 13 constituting the main portion of the self-piercing rivet fastening device is attached to the end of the upper horizontal arm portion of the C-shaped frame 11.

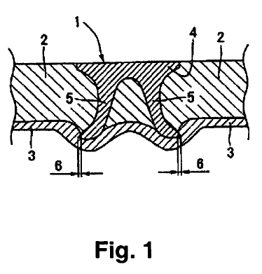

A punch 14 is attached to the end (lower end in FIG. 2) of the fastening mechanism 13 so as to be able to move freely, and a receiver portion 15 is attached to the end of the punch 14. The self-piercing rivet (see the self-piercing rivet 1 in FIG. 1) placed in the receiver portion 15 is driven into the fastened members by the punch 14. A spindle drive 17 is attached above the punch 14 to operate the punch 14 and drive the self-piercing rivet held by the receiving portion. The die 18 is attached to the lower horizontal arm portion at the other end of the C-shaped frame 11. The spindle drive 17 is equipped with an electric motor 19, a decelerating gear mechanism 21 and a gear mechanism 22 for transmitting the rotational force of the motor, and a lead screw 23 that reciprocates vertically with the rotation of the motor. The rotation of the electric motor lowers the lead screw, the motion is transmitted to the punch 14, and the self-piercing rivet held by the receiving portion 15 is driven forcefully in the direction of the die 18. A plurality of fastened members (see fastened members 2, 3 in FIG. 1) is placed in the die 18, the self-piercing rivet is driven into the plurality of fastened members, and the fastened members are fastened together.

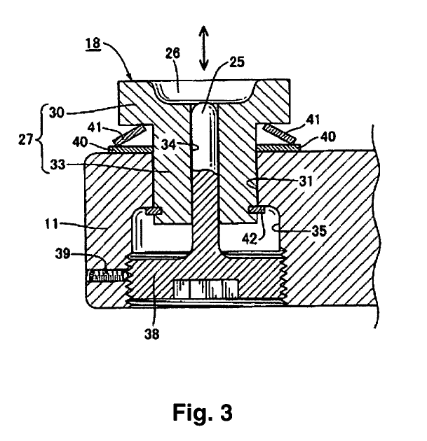

The details of the die 18 of the present invention attached to the other end of the C-shaped frame 11 to receive the self-piercing rivet are shown in FIG. 3. In FIG. 3, the die 18 is equipped with a center pin 25 for receiving the hollow section of the legs on the self-piercing rivet and a die main body 27 having a cavity 26 for guiding the distortion of the tip of the legs on the self-piercing rivet outward radially on the outer periphery of the center pin 25. The center pin 25 and the die main body 27 are supported so as to move relatively freely in the axial direction of the center pin 25 towards the punch 14. In this embodiment, the die main body 27 is supported on the C-shaped frame 11 so as to move freely in the axial direction of the center pin 25, and the tip of the center pin 25 passes through the die main body 27 fixed to the C-shaped frame 11 and protrudes towards the punch 14. The movable die main body 27 comprises a large-diameter tube-shaped portion 30 on the punch end and a small-diameter tube-shaped portion 33 sliding into an attachment hole 31 on the other end of the C-shaped frame 11, and a hole 34 for slidably receiving the center pin 25 passes through the center of both tube-shaped portions forming a hollow tube. A large-diameter center-pin accommodating hole 35 is formed below the attachment hole 31 of the die main body 27 in the C-shaped frame 11, and female threading is formed on the inside wall of the center-pin accommodating hole 35. A large-diameter tube-shaped attachment portion 38 is formed on the center pin 25, and male threading is formed on the outer peripheral surface to accommodate the female threading on the center-pin accommodating hole 35. The attachment portion 38 of the center pin 25 is screwed into the center-pin accommodating hole 35 to attach the C-shaped frame 11. A setscrew 39 is fastened into the C-shaped frame 11 to keep the center pin 25 from coming loose.

The present invention has a means allowing the center pin 25 to move relative to the die main body 27 so the center pin 25 comes into contact with the die end surface of the fastened member on the receiving end when the self-piercing rivet under pressure from the punch 14 is driven into the fastened members and the tip of the legs begins to pierce the fastened member on the receiving end (see fastened member 3 in FIG. 1). In the embodiment shown in FIG. 3, this means is a spring means disposed between the die main body 27 and the C-shaped frame 11 and applies pressure to the die main body 27 on the punch 14 end. More specifically, the spring means is a plate spring 41 disposed between the large-diameter tube-shaped portion 30 and the C-shaped frame 11.

The plate spring 41 is mounted on a base 40 attached to the C-shaped frame 11 to prevent abrasion with the C-shaped frame when the spring plate 41 is bent. The spring action from the plate spring 41 is applied upwardly on the large-diameter tube-shaped portion 30 in the direction of the punch, when the tip of the legs on the self-piercing rivet driven by the punch is driven through the fastened members and enters the fastened member on the receiving end, moving the die main body 27 towards the C-shaped frame 11 and bringing the center pin 25 into contact with the surface of the receiving-end fastened member on the die end when the tip of the legs on the self-piercing rivet driven by the punch begins to pierce the fastened member on the receiving end and strong pressure is applied. A C-ring 42 is attached to the bottom end of the small-diameter tube-shaped portion 33 to keep the spring action of the plate spring from causing the die main body 27 to come loose from the attachment hole 31.

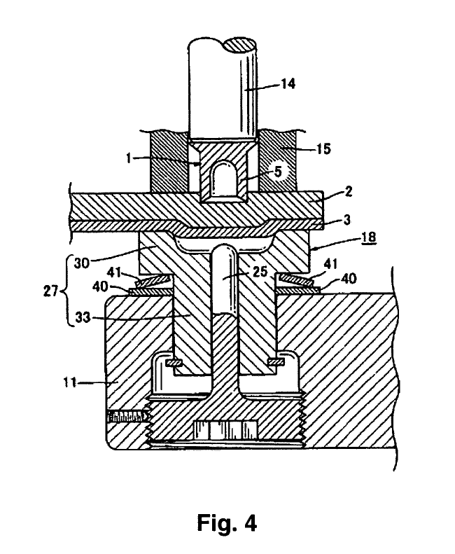

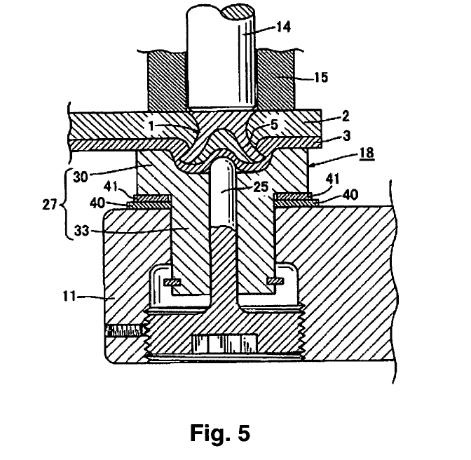

The following is an explanation with reference to FIG. 4 and FIG. 5 of the self-piercing rivet fastening operation performed by the self-piercing rivet fastening device 9. In FIG. 4, a self-piercing rivet 1 is automatically supplied to the receiver portion 15 from the supplying portion (not shown) and is held in the receiver portion 15 below the punch 14. The punch 14 sustains driving force from the spindle motor 7 (FIG. 2), and the self-piercing rivet 1 below is driven into the fastened member 2 on the punch end. The hollow legs 5 of the self-piercing rivet 1 are driven into the fastened member 2. In the first stage, as shown in FIG. 4, the die main body 27 of the die 18 is raised and the center pin 25 does not come into contact with the fastened member 3 on the receiving end adjacent to the die 18. As a result, the legs 5 of the self-piercing rivet penetrate the fastened member 2 without expanding. When the legs 5 of the self-piercing rivet reach the fastened member 3 on the receiving end adjacent to the die, the pressure on the rivet from the punch 14 causes the legs 5 of the rivet to pierce the fastened member on the receiving end 3. When this occurs, the plate spring 41 is bent and the die main body 27 bears down on the C-shaped frame 11. The situation is shown in FIG. 5.

In FIG. 5, the center pin 25 comes into contact with the receiving-end fastened member 3 on the die end when the tip of the legs 5 on the self-penetrating rivet 1 begins to penetrate the fastened member on the receiving end 3 adjacent to the die 18. The center pin 25 resists the pressure of the fastened member on the receiving end receiving pressure from the punch 14, and the portion of the fastened member on the receiving end at the contact point protrudes upwards. Because this position is centered on the rivet legs 5, the tip of the legs 5 on the self-piercing rivet 1 begin to expand outward radially. Consequently, the legs 5 of the self-piercing rivet expand outward radially while penetrating the fastened member on the receiving end. The outward radial expansion of the legs 5 begins after the fastened member on the receiving end has been penetrated, and the radial penetration length of the legs 5 or the amount of undercut is adequate. The two fastened members 2, 3 are held together by the expanded legs 5 and the large-diameter head 4 of the self-piercing rivet 1. In the present invention, the expansion of the legs 5 provides an adequate amount of undercut. The amount of undercut even provides enough joining force when the thickness of the fastened member on the receiving end 3 is less than 1/2 the thickness of the other fastened member 2 (i.e., the fastened member on the punch end). This reduces or eliminates the constraints on the fastened members in the rivet-driving direction. Unlike fastening devices of the prior art, the effort required to reverse the fastening device or reverse the fastened members is reduced or eliminated. Consequently, the fastening process can be performed quickly. Fastening can also be performed in directions impossible using a fastening device of the prior art. This eliminates constraints on fastening positions, and expands the places or positions where a self-piercing rivet can be applied.

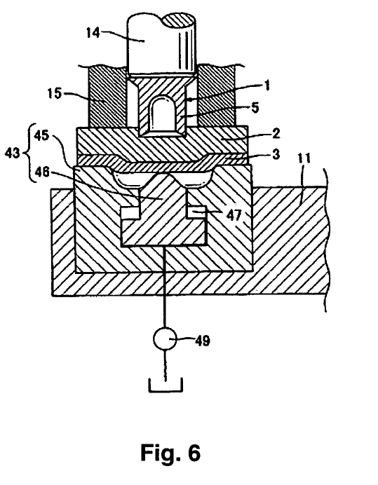

FIG. 6 shows another embodiment of a self-piercing fastening device of the present invention. In this embodiment, the die 43 consists of a die main body 45 fixed to the C-shaped frame 11 facing the punch 14 and a center pin 46 supported so as to move freely inside the die main body 45. Here, a center-pin accommodating chamber 47 is formed in the die main body 45 to allow the tip of the center pin 46 to pass through the die main body and protrude towards the punch 14. The center pin 46 is supported so as to be able to move freely in the axial direction of the pin inside the center-pin accommodating chamber 47.

As a result, in this embodiment, the center pin 46 moves towards the punch 14. The moving means is a fluid pressure or air pressure means supplying fluid pressure or air pressure from a pump 49 through the bottom of the center-pin accommodating chamber 47 to push the center pin 46 against the punch end. Here, the fluid pressure or air pressure means does not move the center pin 46 when the tip of the legs 5 on the self-piercing rivet driven by the punch 14 is driven through the fastened member on the punch end 2 and enters the fastened member on the receiving end 3, but brings the center pin 46 into contact with the surface of the receiving-end fastened member 3 on the die end when the tip of the legs 5 on the self-piercing rivet driven by the punch 14 begins to pierce the fastened member on the receiving end 3 and strong pressure is applied. As in the explanation with reference to FIG. 4 and FIG. 5 using the die 43 in FIG. 6, the legs 5 of the self-piercing rivet 1 penetrate the fastened member on the receiving end 3 with a sufficient amount of undercut.

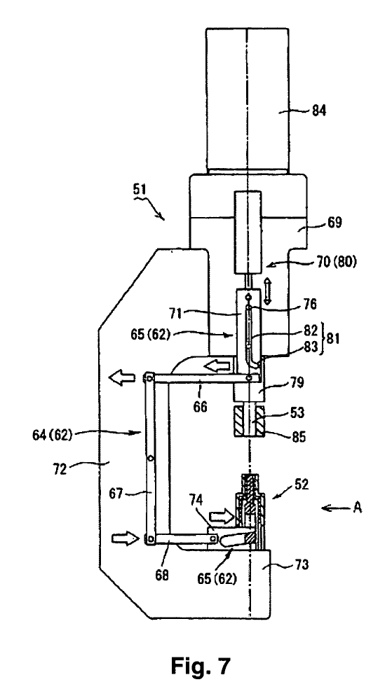

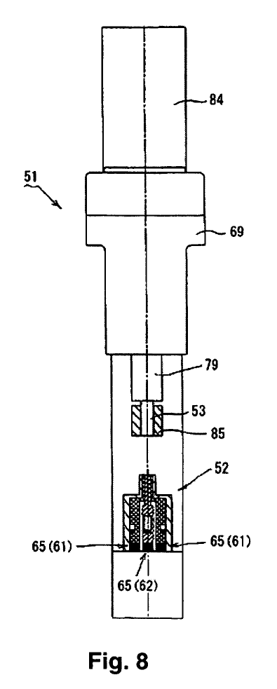

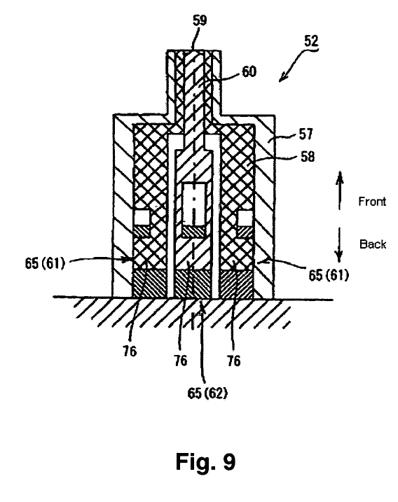

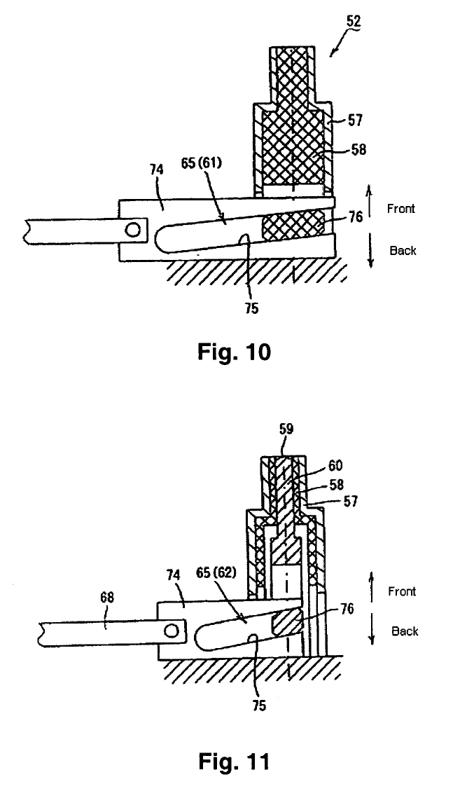

Next, embodiments of the present invention corresponding to the second purpose will be explained. FIG. 7 is a partial cross-sectional view from the side of the self-piercing rivet fastening device of the present invention. FIG. 8 is a partial cross-sectional view of the fastening device in FIG. 7 from direction A. FIG. 9 through FIG. 11 are enlarged cross-sectional views of the die in FIG. 7. The self-piercing rivet fastening device (51) of the present invention is equipped with a die (52) and a punch (53) reciprocating in the direction of the die. The peripheral surface of the punch (53) is surrounded by a tube-shaped receiver portion (85).

The following is an explanation of the constituent elements. As shown in FIG. 7, the die (52) deforms and fastens the hollow legs (55) of a self-piercing rivet (56) consisting of a large-diameter head (54) and hollow legs (55) extending down from the head (54).

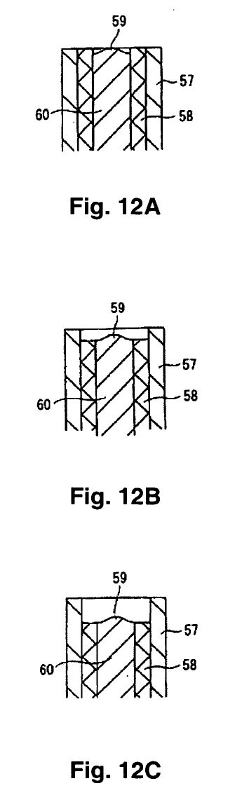

As shown in FIG. 12, the die (52) consists of an outer tube (57), an inner tube (58) making contact with the inside surface of the outer tube (57) and able to move forward and backward inside the outer tube (57), and a center pin (60) having a protrusion (59) in the center of the tip making contact with the inside surface of the inner tube (58) and able to move forward and backward inside the inner tube (58), and the die is connected to an inner-tube moving means (61) for moving the inner tube (58) forward and backward and a center-pin moving means (62) for moving the center pin (60) forward and backward. In FIG. 7, only the center-pin moving means (62) is shown. The inner-tube moving means (61) is not shown.

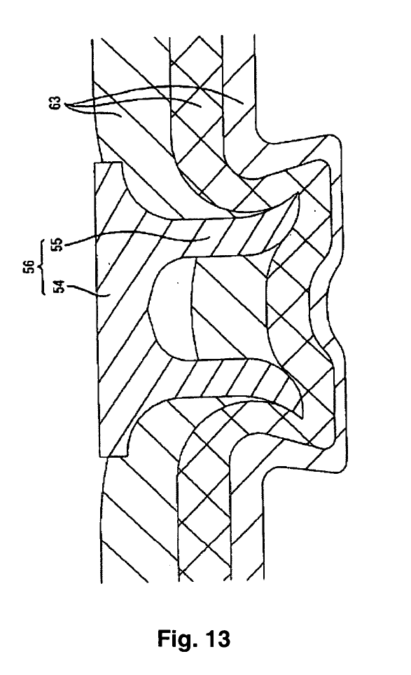

The moving means (61) (62) move with the punch (53). The tip of the inner tube (58), the tip of the protrusion (59) on the center pin (60) and the tip of the outer tube (57) are roughly coplanar until the self-piercing rivet (56) (see FIG. 13) punches through a fastened member (63) lengthwise based on the conditions of the thickness of the fastened member (63) and the overall length of the self-piercing rivet (56) (see FIG. 9 through FIG. 11 and FIG. 12A).

The inner tube (58) and the center pin (60) move backward separately to specific positions and stop after the self-piercing rivet (56) punches through a fastened member (63) lengthwise based on the conditions of the thickness of the fastened member (63) and the overall length of the self-piercing rivet (56). The speed at which the inner tube (58) and the center pin (60) move backwards at this time is approximately the same speed as the punch (53), and the edge of the tip on the center pin (60) and the tip of the inner tube (58) are roughly coplanar when the inner tube (58) and the center pin (60) reach their respective positions (see FIG. 12C).

When the inner tube (58) and the center pin (60) reach their respective positions backward, the edge of the tip on the center pin (60) and the tip of the inner tube (58) should be roughly coplanar. However, the edge of the tip on the center pin (60) can be somewhat forward of the tip of the inner tube (58). When the edge of the tip on the center pin (60) is somewhat forward, the deformation of the underlying fastened member (63) is not obstructed.

In the initial stage (see FIG. 12A) and the final stage (see FIG. 12C) of the fastening process, the edge of the tip on the center pin (60) and the tip of the inner tube (58) in the die (52) are coplanar (see FIG. 12B). At this time, the edge of the tip on the center pin (60) and the tip of the inner tube (58) should be roughly coplanar. However, the edge of the tip on the center pin (60) can be somewhat forward of the tip of the inner tube (58).

In the intermediate stage, the edge of the tip on the center pin (60) and the tip of the inner tube (58) are roughly coplanar. The positional relationship between the edge of the tip on the center pin (60) and the tip of the inner tube (58) remain the same as the edge of the tip on the center pin (60) and the tip of the inner tube (58) move towards their specific positions in the final stage (see FIG. 12C).

The specific configurations of the inner-tube moving means (61) and the center-pin moving means (62) are not restricted. However, the following configurations can be used. As shown in FIG. 7 through FIG. 11, the inner-tube moving means (61) and the center-pin moving means (62) consist of ring mechanisms (64) and cam mechanisms (65) for converting the movement of the punch (53) into forward and backward movement for the inner tube (58) and the center pin (60). The ring mechanisms (64) can be used to move the inner tube (58) and move the center pin (60). These ring mechanisms (64) can be separate. In FIG. 7, they are only used for the center pin (60)). The ring mechanisms (64) are connected to the movement of the punch (53).

As shown in FIG. 7, the ring mechanisms (64) can consist of three-joint mechanisms. The three-joint mechanisms (64) have a first joint (66) and a third joint (68) connected via an intermediate second joint (67). The outer end of the first joint (66) is a pin joint connected rotatably to a guide plate (71) attached to the side surface of the block cover (69) via a guide plate moving device (70). The second joint (67) in the middle is a pin joint connected rotatably to the frame (72) between the punch (53) and the die (52). The third joint (68) on the outer end is a pin joint connected rotatably to the slider (74) attached to the support base (73) of the die (52).

The slider (74) slides at a right angle to the moving direction of the punch (53). The slider (74) has a first cam groove (75) extending linearly at a shallow angle of inclination in the entire sliding direction of the slider (74). Driven members (76) are installed in the first cam groove (75). The driven members (76), as shown in FIG. 9, are attached to the inner tube (58) and the center pin (60). By sliding the slider (74), the driven members (76) are moved forward and backward in the first cam groove (75), and the inner tube (58) and the center pin (60) move separately forward and backward.

A guide plate moving device (70) is attached to the side surface of the immovable block cover (69) to the outside of the slide block (79). The guide plate moving device (70) moves the guide plate (71) described below forward and backward. The guide plate moving device (70) consists of a slider device and a motor power source. The main body of the moving device (70) is fixed to the block cover (69), and the driven portion of the moving device (70) such as a rod is rotatably attached to the guide plate (71) using a pin joint. The guide plate moving device (70) is the stop position setting means (80) for setting and changing the backward stop position of the inner tube (58) and the backward stop position of the center pin (60) with respect to the fastened members (63) based on the thickness of the fastened members (63) and/or the overall length of the self-piercing rivet (56).

The stop position setting means (80) (see FIG. 7) consists of the guide plate moving device (70) and the controller (not shown) for controlling the operation of the device (70). The controller is a computer that calculates the optimum backward stop positions for the inner tube (58) and the center pin (60) based on the thickness, number and stacking order of the fastened members (63) and the overall length of the self-piercing rivet (56). A operational command based on the results of the calculation is sent to the guide plate moving device (70) for the inner tube (58) and the center pin (60). The conditions such as the thickness of the fastened members (63) can be entered manually by the operator, or the controller can perform the calculation automatically based on a thickness measurement performed by sensors.

The fastening device (51) is attached to the end of a robot arm (not shown) and the fastening device (51) is moved to the desired position with respect to the fastened members (63) by moving the robot arm. The movement of the robot arm is controlled by the computer. Data such as the fastening positions and fastening positions corresponding to the thickness of fastened members are stored in the computer. The data related to the fastening positions and fastening positions corresponding to the thickness of fastened members are outputted to the controller of the fastening device (51). The data related to the thickness of the fastened members at each fastening position are inputted to the controller automatically.

When the thickness of the fastened members (63) is measured, the following measurements are made. First, the distance (dl) between the bottom end of the receiver portion (85) and the top end of the outer tube (57) of the die (52) is set, and the value is stored in the controller. Before the fastened members are riveted together and pressed into the desired shape, the receiver portion (85) in front of the punch (53) is brought into contact with the fastened member (63), the receiver portion (85) is pressed against the fastened members (63), and the moving distance (d2) from the initial position of the receiver portion (85) to the stop position is measured using various sensors (not shown).

The measurements are outputted to the controller. The controller subtracts d2 from dl. The result of the calculation is the overall thickness (d3) of the fastened members (63). The measured value (d3) is used as the thickness condition for the fastened members (63).

The measured value (d3) is compared to the stored thickness of the fastened members (63). If the difference is within a certain tolerance, the depth of the cavity in the die (52) is set automatically and the fastening operation is performed. If the difference is outside the tolerance, an alarm can be sounded. Because stacking of fastened members (63) can be a problem, this method has the advantage of not wasting fastened members (63). If the measured thickness value (d3), the depth of the cavity of the adjusted die (52), and the state of the cam mechanisms (65) are stored in a memory medium, this valuable data can be used again.

The guide plate (71) has a second cam groove (81). Driven members (76) attached to the side surface of the slide block (79) are installed in the second cam groove (81). The slide block (79) moves with the punch (53).

The second cam groove (81) has a straight portion extending in the moving direction of the punch (53) and a curved portion (83) extending along a curve from the end of the linear portion (82). When the slide block (79) advances and the driven members (76) enter the curved portion (83), the guide plate (71) rotates, and the first joint (66) moves at a right angle to the moving direction of the punch (53). The third joint (68) moves in the opposite direction of the first joint (66) via the second joint (67). The slider (74) moves with the third joint (68).

The following is an explanation of the operation of the fastening device (51). First, the distance (dl) between the bottom end of the receiver portion (85) and the top end of the outer tube (57) of the die (52) is set, and the value is stored in the controller. Data related to the fastened member thickness and overall length of the self-piercing rivet are stored in the controller. A self-piercing rivet (56) is loaded in the tip of the punch (53) and, for example, three fastened members (63) are stacked on the die (52). A command for moving the guide plate (71) forward or backward based on the data related to the fastened member thickness and overall length of the self-piercing rivet is sent by the controller to the guide plate moving device (70). The guide plate moving device (70) then moves the guide plate (71) based on the command.

After the guide plate (71) has been moved, the receiver portion (85) is moved forward with the punch (53), and the tip of the receiver portion (85) is brought into contact with the top fastened member (63). At this time, the distance (d2) from the start to the stop of the receiver portion (85) is detected by a sensor (not shown), and the detected value (d2) is subtracted by the controller from the distance (dl) between the receiver portion (85) and the die (52).

The calculated value (d3) is the measured value for the overall thickness of the fastened members (63). The measured value is based on the fastened member thickness and overall length of the self-piercing rivet stored beforehand for the fastening positions, and the optimum backward stop positions for the inner tube (58) and the center pin (60) are calculated by the controller based on the conditions of the fastened members (63) and the self-piercing rivet (56).

The measured value is compared to the stored thickness of the fastened members. If the difference is within a certain tolerance, the depth of the cavity in the die is set automatically and the fastening operation is performed. If the difference is outside the tolerance, an alarm can be sounded without performing the fastening operation. If the tolerance is exceeded a little, the fastening can be performed by adjusting the depth of the cavity of the die (52). In this way, the depth of the cavity of the die (52) can be adjusted automatically, and the main fastening operation can be performed.

After the main fastening operation has been approved, the punch (53) is advanced by the drive device (84) (see FIG. 7), and the main fastening operation is performed. The inner tube moving means (61) and the center pin moving means (62) move with the punch (53). The tip of the inner tube (58), the tip of the protrusion (59) on the center pin (60) and the tip of the outer tube (57) are roughly coplanar until the self-piercing rivet (56) punches through a fastened member (63) lengthwise based on the conditions of the thickness of the fastened member (63) and the overall length of the self-piercing rivet (56) (see FIG. 12A).

The inner tube (58) and the center pin (60) move backward separately to specific positions and stop after the self-piercing rivet (56) punches through a fastened member (63) lengthwise based on the conditions of the thickness of the fastened member (63) and the overall length of the self-piercing rivet (56). The speed at which the inner tube (58) and the center pin (60) move backwards at this time is approximately the same speed as the punch (53), and the edge of the tip on the center pin (60) and the tip of the inner tube (58) are roughly coplanar when the inner tube (58) and the center pin (60) reach their respective positions (see FIG. 12C).

At this time, the fastening members (63) are fastened together by the self-piercing rivet (56) without the seal being broken, and without gaps opening between the self-piercing rivet (56) and the fastening members (63) or between fastening members (63) themselves (see FIG. 13). After the fastening operation has been completed, the punch (53) retreats with the receiver portion (85), and the inner tube (58) and the center pin (60) return to their original positions. The fastened members are automatically removed by the inner tube (58) and the center pin (60). With this, the fastening operation comes to an end.

By performing the fastening operation in these stages, the bottom fastened member (63) is supported by the protrusion (59) on the center pin (60) and the inner tube (58). When the deforming and fastening is performed lengthwise based on the conditions of the thickness of the fastened member (63) and the overall length of the self-piercing rivet (56), the fastening operation is performed with a high degree of freedom inside the large cavity in the tip of the inner tube (58) withdrawn in coplanar fashion with the edge of the tip of the center pin (60) (see FIG. 12B). In the final fastening stage, the fastened members (63) are fastened inside the cavity corresponding to the final fastening shape (FIG. 12C). As a result, the bottom fastened member (63) is not subjected to unnecessary force, the seal is not broken, a gap does not open up between the self-piercing rivet and the fastened members or between the fastened members themselves, and the fastened member near the head of the self-piercing rivet is not significantly deformed.

Because the controller changes the conditions for the fastened members (63), the fastening is performed in such a way that the seal is not broken, a gap does not open up between the self-piercing rivet and the fastened members or between the fastened members themselves, the fastened member near the head of the self-piercing rivet is not significantly deformed, and the self-piercing rivet (replace the self-piercing rivet with one of a different length) and the die (replace the die with one of a different cavity diameter or cavity depth) do not have to be replaced even though the thickness, number and quality of fastened members (63) change.

1. A self-piercing rivet fastening device having a punch and die for driving a self-piercing rivet with a large-diameter head and hollow legs extending below the head into a plurality of fastened members, the tip of the legs becoming deformed as the legs penetrate the fastened members when the self-piercing rivet is driven into the fastened members so as to expand outward radially, the tip of the legs not penetrating the fastened member on the receiving end adjacent to the die but remaining inside, the plurality of fastened members being connected to each other by the deformed legs and the large-diameter head, wherein the die comprises a center pin in the position receiving the hollow section of the legs on the self-piercing rivet and extending towards the punch as well as a die main body with a cavity for guiding the outward radial deformation of the tip of the legs on the self-piercing rivet, wherein the center pin and the die main body are supported so as to move relatively freely in the radial direction of the center pin towards the punch, and wherein the device has a means allowing the center pin to move relative to the die main body so the center pin comes into contact with the die end surface of the fastened member on the receiving end when the self-piercing rivet under pressure from the punch is driven into the plurality of fastened members and the tip of the legs begins to pierce the fastened member on the receiving end.

2. The device described in claim 1, wherein the device is equipped with a C-shaped frame, wherein the punch is attached at one end of the C-shaped frame so as to move towards the other end of the C-shaped frame, wherein the die is attached to the other end of the C-shaped frame facing the punch so as to receive the self-piercing rivet driven by the punch, wherein the die main body is supported by the other end of the C-shaped frame so as to be able to move in the axial direction of the center pin, wherein the center pin is fixed to the other end of the C-shaped frame in order to penetrate the die main body so the tip of the pin protrudes towards the punch, and wherein the means for moving the center pin relative to the die main body is a spring means disposed between the ends of the C-shaped frame and applying pressure to the die main body on the punch end.

3. The device described in claim 2, wherein the movable die main body comprises a large-diameter tube-shaped portion on the punch end and a small-diameter tube-shaped portion sliding into an attachment hole on the other end of the C-shaped frame, wherein a hole for slidably receiving the center pin passes through the center of both tube-shaped portions forming a hollow tube, wherein the spring means is a plate spring attached between the large-diameter tube-shaped portion and the C-shaped frame, and wherein the spring action from the plate spring forces the movable die main body towards the punch end when the tip of the legs on the self-piercing rivet driven by the punch is driven through the fastened members and enters the fastened member on the receiving end, moving the die main body towards the C-shaped frame and bringing the center pin into contact with the surface of the receiving-end fastened member on the die end when the tip of the legs on the self-piercing rivet driven by the punch begins to pierce the fastened member on the receiving end and strong pressure is applied.

4. The device described in claim 3, wherein the other end of the C-shaped frame has an attachment hole for slidably accommodating the small-diameter tube-shaped portion of the die main body, wherein a large-diameter center-pin accommodating hole continuing the attachment hole is formed on the opposite side of the other end of the C-shaped frame facing the punch end, wherein the small-diameter tube-shaped portion of the die main body is slidably attached to the attachment hole, wherein female threading is formed on the inside wall of the center-pin accommodating hole, and wherein the center pin is screwed into the female threading.

5. The device described in claim 1, wherein the device is equipped with a C-shaped frame, wherein the punch is attached at one end of the C-shaped frame so as to move towards the other end of the C-shaped frame, wherein the die is attached to the other end of the C-shaped frame facing the punch so as to receive the self-piercing rivet driven by the punch, wherein the die main body is fixed to the other end of the C-shaped frame, wherein a center-pin accommodating chamber is formed in the die main body to allow the tip of the pin to pass through the die main body and protrude towards the punch, wherein the center pin is supported so as to be able to move freely in the axial direction of the pin inside the center-pin accommodating chamber, and wherein the means for moving the center pin relative to the die main body is a fluid pressure or air pressure means using fluid pressure or air pressure to push the center pin against the punch end.

6. The device described in claim 5, wherein the fluid pressure or air pressure means does not move the center pin when the tip of the legs on the self-piercing rivet driven by the punch is driven through the fastened members and enters the fastened member on the receiving end, but brings the center pin into contact with the surface of the receiving-end fastened member on the die end when the tip of the legs on the self-piercing rivet driven by the punch begins to pierce the fastened member on the receiving end and strong pressure is applied.

7. A riveting apparatus comprising:
a die having a body including an elongated bore and a rivet-deforming cavity intersecting the bore, the cavity being openly accessible from a workpiece-side of the die; and
a rivet-expanding member located in the bore, at least one of the member and die being automatically moveable relative to the other during a riveting operation;
the member being substantially withdrawn from the cavity of the die during a first rivet insertion condition; and
the member projecting into the cavity of the die during a second and subsequent rivet insertion condition.

8. The apparatus of claim 7 wherein the member is an elongated pin which is slideably moveable in the bore of the die.

9. The apparatus of claim 8 wherein the member is slideable in the bore of the die in a linear direction substantially coaxial with a rivet insertion axis of movement.

10. The apparatus of claim 7 further comprising a rivet, and at least a punch-side workpiece and a die-side workpiece, the member being completely withdrawn from the cavity of the die prior to a leading tip of the rivet being inserted into the die-side workpiece, and the member projecting into the cavity of the die substantially during insertion of the leading tip of the rivet into the die-side workpiece.

11. The apparatus of claim 7 wherein positioning of the member relative to the cavity assists in diverging a leading tip of a rivet during insertion.

12. The apparatus of claim 7 further comprising a center pin including the member and an attachment portion, the attachment portion being transversely larger than the member in a direction substantial perpendicular to the elongated direction of the member, and the attachment portion having an attachment thread.

13. The apparatus of claim 7 wherein the die is moveable in a linear direction substantially parallel to a rivet insertion direction and the elongated member is substantially stationary during rivet insertion.

14. The apparatus of claim 7 further comprising a rivet advancing punch automatically moveable toward and away from the die, a C-frame mounted to the punch and the die, and a cam operably moving at least one of the member and the die relative to the other depending at least in part on the rivet insertion condition.

15. The apparatus of claim 7 wherein the die further comprises:
an inner tube and an outer tube;
the member, inner tube and outer tube being concentrically oriented with each other; and
the inner tube being moveable relative to the outer tube and the member being moveable relative to the inner tube.

16. The apparatus of claim 7 further comprising a programmable controller operably determining real-time riveting characteristics and causing movement of at least one of the die and the member based at least in part on the determination.

17. A riveting apparatus comprising:
a rivet including a leading tip;
a punch operably advancing the rivet;
a punch-side workpiece;
a die-side workpiece;
a die including a recessed surface; and
a pin coaxially aligned with the punch;
the workpieces being positionable between the punch and the die during rivet insertion;
wherein the projection distance of the pin relative to the recessed surface of the die is varied depending upon the desired start of divergence of the rivet into the workpieces, the pin having a greater projection when the leading tip of the rivet engages the die-side workpiece as compared to when the leading tip of the rivet initially passes through the punch-side workpiece.

18. The apparatus of claim 17 wherein the pin is elongated and slideably moveable in a through-bore of the die.

19. The apparatus of claim 18 wherein the pin is slideable in the bore of the die in a linear direction substantially coaxial with a rivet insertion axis of movement, an end of the pin being rounded.

20. The apparatus of claim 17 wherein the pin is fully withdrawn from the recessed surface of the die prior to the leading tip of the rivet being inserted into the die-side workpiece, and the pin projects into the recessed surface of the die during insertion of the leading tip of the rivet into the die-side workpiece.

21. The apparatus of claim 17 wherein positioning of the pin relative to the recessed surface assists in diverging the leading tip of the rivet during insertion.

22. The apparatus of claim 17 further comprising an attachment portion affixed to the pin, the attachment portion being transversely larger than the pin in a direction substantial perpendicular to the elongated direction of the pin, and the attachment portion having an attachment thread.

23. The apparatus of claim 17 wherein the die is moveable in a linear direction substantially parallel to the advancing direction of the punch, and the pin is substantially stationary during rivet insertion.

24. The apparatus of claim 17 further comprising a C-frame mounted to the punch and the die, and a cam operably moving at least one of the pin and the die relative to the other depending at least in part on a rivet insertion position.

25. The apparatus of claim 17 wherein the die further comprises:
an inner tube and an outer tube;
the member, inner tube and outer tube being concentrically oriented with each other; and
the inner tube being moveable relative to the outer tube and the pin being moveable relative to the inner tube.

26. The apparatus of claim 17 further comprising a programmable controller operably determining real-time riveting characteristics and causing movement of at least one of the die and the pin based at least in part on the determination.

27. A riveting system comprising:
a self-piercing rivet;
a punch-side panel;
a die-side panel;
an automatically moveable punch operably driving the rivet into the panels;
a die assembly aligned with the punch, the panels being positionable between the punch and the die assembly;
wherein the punch and die assembly act to delay divergence of a leading end of the rivet until when the leading end begins penetration of the die-side panel during rivet installation.

28. The system of claim 27 wherein the die assembly further comprises a die and an elongated pin slideably moveable in a bore of the die.

29. The system of claim 28 wherein the pin is slideable in the bore of the die in a linear direction substantially coaxial with a rivet insertion axis of movement.

30. The system of claim 28 wherein the pin is somewhat withdrawn from a die cavity prior to a leading end of the rivet being inserted into the die-side panel, and the pin projects into the die cavity during insertion of the leading end of the rivet into the die-side panel.

31. The system of claim 28 further comprising a cam operably moving at least one of the member and the die relative to the other depending at least in part on the rivet insertion condition.

32. The system of claim 27 wherein positioning of a pin of the die assembly relative to a die cavity assists in diverging the leading end of the rivet during insertion.

33. The system of claim 27 wherein the die assembly includes a die and a pin, the die is moveable in a linear direction substantially parallel to a rivet insertion direction and the pin is substantially stationary during rivet insertion.

34. The system of claim 27 wherein the die assembly further comprises:
a pin, an inner tube and an outer tube;
the pin, inner tube and outer tube being concentrically oriented with each other; and
the inner tube being moveable relative to the outer tube and the pin being moveable relative to the inner tube.

35. The system of claim 27 further comprising a programmable controller operably determining real-time riveting characteristics and causing movement of the die assembly based at least in part on the determination.

36. A riveting machine comprising:
a rivet advancing punch;
a die assembly having a moveable member; and
an actuation assembly operably moving the member of the die assembly to correspond with a characteristic of the punch.

37. The machine of claim 36 wherein the actuation assembly further comprises a first cam and a first cam follower.

38. The machine of claim 37 wherein the actuation assembly includes a second cam and a second cam follower positioned adjacent the punch, and the first cam and first cam follower being positioned adjacent the die assembly.

39. The machine of claim 36 wherein the punch characteristic is location of a feature moving with the punch.

40. The machine of claim 36 wherein the actuation assembly further comprises mechanical linkages.

41. The machine of claim 36 further comprising a self-piercing rivet, wherein varying the positioning of the member relative of the remainder of the die assembly affects the timing of rivet deformation during insertion.

42. The machine of claim 36 further comprising a programmable controller operably determining real-time riveting characteristics and causing movement of the die assembly based at least in part on the determination.

43. A workpiece joining die comprising:
a stationary outer member having a workpiece contacting edge;
an inner member moveably located within the outer member, the inner member having a workpiece contacting edge; and
a central member moveably located internal to the inner and outer members, the central member having a workpiece contacting peak;
the central, inner and outer members all being coaxially aligned adjacent their workpiece contacting peak and edges;
wherein a tip of the peak and the workpiece contacting edges are all substantially coplanar when in a first workpiece joining condition; and
wherein the peak and workpiece contacting edge of the inner member are retracted below the workpiece contacting edge of the outer member when in a second workpiece joining condition.

44. The die of claim 43 wherein the workpiece contacting edges of the inner and outer members are each substantially cylindrical and concentrically arranged.

45. The die of claim 43 further comprising a cam and a cam follower, selective movement of the cam and the cam follower causing movement of the central member relative to the outer member.

46. The die of claim 43 wherein the workpiece engaging edges of the inner and outer members and the workpiece engaging peak of the central member operably diverge a leading tip of a self-piercing rivet.

47. A riveting machine comprising:
a structure having a hollow section;
a die including a workpiece contacting surface and a body, the body being located in the hollow section; and
a substantially T-shaped member having an elongated pin and an enlarged retainer, the retainer being removeable secured to the structure;
the pin projecting through an opening in the workpiece contacting surface of the die; and
the die being moveable relative to the structure and the pin.

48. The machine of claim 47 further comprising a spring located between the structure and the die.

49. The machine of claim 48 wherein the die has an enlarged flange located external to the hollow section of the structure, the workpiece contacting surface is disposed adjacent the enlarged flange, and the spring being located between the enlarged flange and the structure.

50. The machine of claim 47 wherein the retainer is externally threaded for engagement with internal threads of the structure.

51. The machine of claim 47 wherein the structure is a robotically moveable C-frame and the workpiece contacting surface of the die and the pin act to deform a self-piercing rivet.

52. A riveting system comprising:
a rivet-driving punch;
a rivet-deforming die assembly aligned with the punch; and
a controller operably determining a riveting characteristic and automatically varying the die assembly.

53. The system of claim 52 wherein the die assembly includes a die having a workpiece interfacing cavity and a bore intersecting the cavity, and a center pin operably advancing and retracting through the bore and into the cavity based on relative movement between the die and the pin, wherein the relative positioning of the pin and the die is varied by the controller.

54. The system of claim 53 wherein the pin is moveable and the die is stationary.

55. The system of claim 53 wherein the die includes an outer tube, and an inner tube is moveably positioned within the outer tube and the pin is moveably positioned within the inner tube.

56. The system of claim 52 wherein the controller automatically calculates a workpiece thickness based on sensed signals.

57. The system of claim 52 wherein the controller compares real-time sensed riveting characteristics to previously stored data for use in varying the die assembly.

58. The system of claim 52 wherein the controller varies the die assembly based at least in part on a rivet length value.

59. The system of claim 52 further comprising;
a rivet operably driven by the punch;
a punch-side workpiece; and
a die-side workpiece;
wherein the controller operably varies the die to cause the desired amount of undercut engagement of the rivet with the die-side workpiece.

60. The system of claim 52 further comprising a self-piercing rivet operably driven by the punch, the rivet being prevented from directly contacting against the die assembly.

61. The system of claim 52 further comprising an actuation mechanism operably varying the die assembly in response to a signal from the controller, the actuation assembly including at least one cam and at least one mechanical linkage.

62. A riveting control system comprising:
memory including stored data values indicative of a desired die configuration to achieve a desired riveted joint;
real-time riveting characteristics sensed and compared to the previously stored data;
a controller operably calculating if die configuration variations are required and if so, sending a die configuration varying signal; and
causing rivet insertion with the varied die configuration to achieve desired joint engagement.

63. The system of claim 62 wherein the riveting characteristic is rivet length.

64. The system of claim 62 wherein the riveting characteristic is workpiece thickness.

65. The system of claim 62 wherein the die configuration is the relative positioning of a workpiece-interfacing pin with a workpiece-interfacing die in order to delay rivet divergence until a die-side workpiece is engaged by a rivet.

66. A method of manufacturing a joint by installing a rivet into workpieces using a riveting machine, the machine including a driving member, a first rivet-deforming member, and a second rivet-deforming member, the method comprising:
(a) advancing the rivet toward the workpieces with the driving member;
(b) causing the rivet to penetrate a first of the workpieces without substantially diverging;
(c) projecting the first rivet-deforming member further past a workpiece interfacing surface of the second rivet-deforming member after at least initiation of step (b); and
(d) penetrating a second of the workpieces with the rivet in coordination with step (c) to cause diverging of the rivet.

67. The method of claim 66 further comprising a controller automatically varying the positioning of the first rivet-deforming member relative to the second rivet-deforming member.

68. The method of claim 67 further comprising varying the relationship of the first and second rivet-deforming members based on real-time sensed values.

69. A method of claim 66 further comprising preventing the rivet from completely piercing through the workpiece closest to the rivet-deforming members.

70. The method of claim 66 wherein the first rivet-deforming member is an elongated pin and the second rivet-deforming member is a die having a recessed cavity.

71. The method of claim 66 further comprising supplying a camming motion to move the first rivet-deforming member relative to the second rivet-deforming member.
